(19) United States
(12) Patent Application Publication
(10) Pub. No.: US 2016/0273266 A1
(43) Pub. Date: Sep. 22, 2016

(54) Window shade

(71) Applicant: Jui Fang WU, Taichung City (TW)

(72) Inventor: Jui Fang WU, Taichung City (TW)

(73) Assignee: PINNOKI CO., LTD., Taichung City (TW)

(21) Appl. No.: 14/663,472

(22) Filed: Mar. 20, 2015

(51) Int. Cl. E06B 9/24

(52) U.S. Cl. CPC E06B 9/24

(57) ABSTRACT

A window shade contains: at least one mounting holder and two shading assemblies mounted on two sides of a glass window. Each mounting holder includes a sucking portion and a connecting portion, a first surface of the sucking portion is an adhesion face for adhering each mounting holder with the glass window, and a second surface of the sucking portion is an external face formed with the connecting portion, the connecting portion has two retaining slots defined on two peripheral sides thereof. Each shading assembly includes an adjustable shading cloth which is pulled outwardly, and the adjustable shading cloth has a positioning post disposed on one side thereof to retain with each of the two retaining slots.

### FIELD OF THE INVENTION

The present invention relates to a window shade which is pulled from its one side or its two sides to satisfy different using requirements.

### BACKGROUND OF THE INVENTION

A conventional window film is adhered on a glass window of a car to shield sunshine, but high temperature still produces in the car.

A conventional window shade is fixed on a glass window of a car to cooperate with the window film, and it is rolled or is collapsible. However, such a conventional window shade is mounted on one side of the glass window, and a fixing seat is fixed on another side of the glass window to fasten with the window shade, so the conventional window shade is pulled from its one side merely.

The present invention has arisen to mitigate and/or obviate the afore-described disadvantages.

### SUMMARY OF THE INVENTION

The primary objective of the present invention is to provide a window shade which is pulled from its one side or its two sides to satisfy different using requirements.

To obtain the above objective, a window shade provided by the present invention contains: at least one mounting holder and two shading assemblies mounted on two sides of a glass window. Each mounting holder includes a sucking portion and a connecting portion, a first surface of the sucking portion is an adhesion face for adhering each mounting holder with the glass window, and a second surface of the sucking portion is an external face formed with the connecting portion, the connecting portion has two retaining slots defined on two peripheral sides thereof. Each shading assembly includes an adjustable shading cloth which is pulled outwardly, and the adjustable shading cloth has a positioning post disposed on one side thereof to retain with each of the two retaining slots.

In operation, two mounting holders are fixed on two ends of a middle section of the glass window, and two retaining slots of the connecting portion of each mounting holder correspond to the two sides of the glass window, then each adjustable shading cloth of each shading assembly is pulled outwardly so that the positioning post retains with each retaining slot, thus expanding and fixing each adjustable shading cloth.

Preferably, the two retaining slots are located on the two peripheral sides of the connecting portion at two different heights.

Preferably, each shading assembly further includes a plurality of suckers arranged thereon and a locking groove extending from a top end of each shading assembly to a bottom end of each shading assembly, wherein each sucker has a retaining block arranged on one end thereof to slidably retain each sucker with the locking groove.

Preferably, a width of an opening of the locking groove is less than an inner surface of the locking groove, and the retaining block of each sucker has a narrow section and a wide section which cooperate with a profile of the locking groove.

### BRIEF DESCRIPTION OF THE DRAWINGS

FIG. 1 is a perspective view showing the application of a shade window according to a preferred embodiment of the present invention.

FIG. 2 is a perspective view showing the assembly of a mounting holder of the shade window according to the preferred embodiment of the present invention.

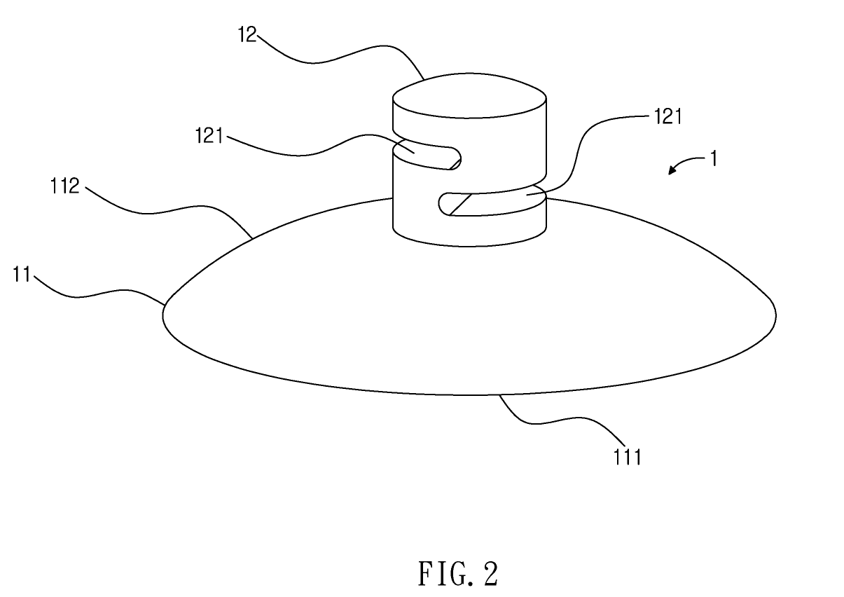

FIG. 3 is a perspective view showing the operation of the shade window according to the preferred embodiment of the present invention.

FIG. 4 is a side plan view showing the operation of the shade window according to the preferred embodiment of the present invention.

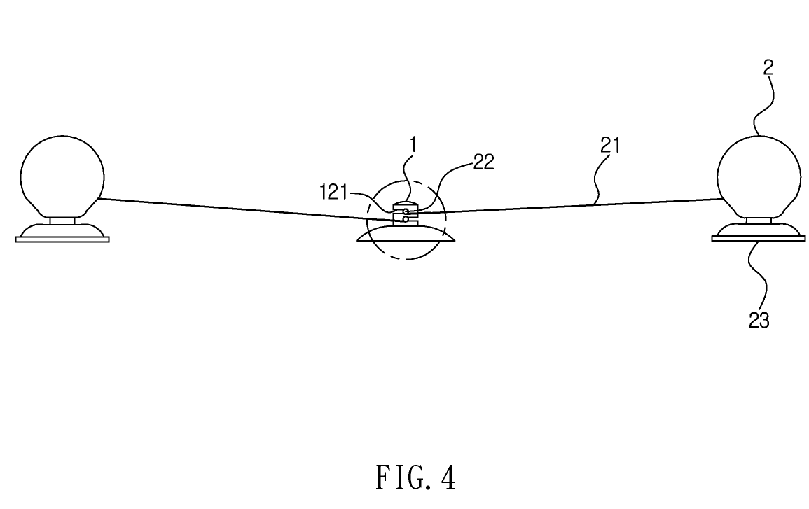

FIG. 5 is an amplified cross sectional view of the mounting holder of FIG. 4.

FIG. 6 is a perspective view showing the assembly of a sucker and the mounting holder of the shade window according to the preferred embodiment of the present invention.

FIG. 7 is another perspective view showing the operation of the shade window according to the preferred embodiment of the present invention.

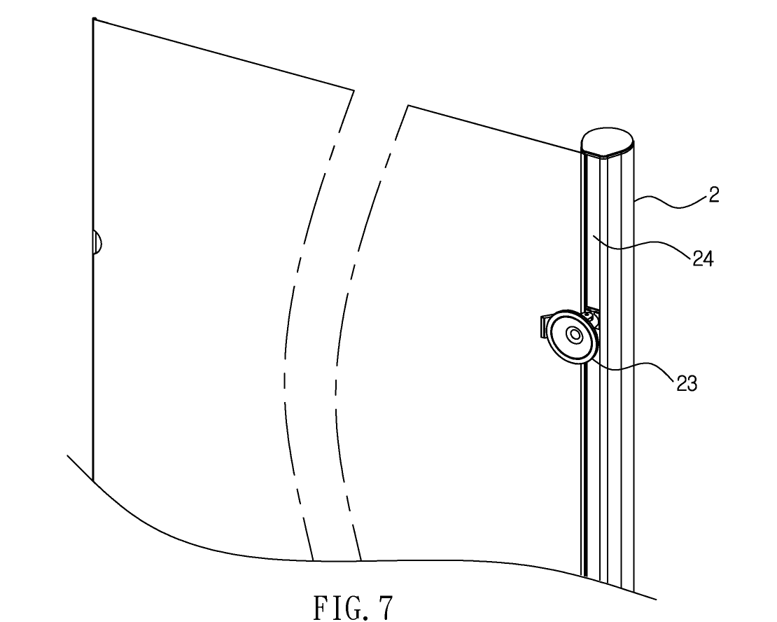

FIG. 8 is also another perspective view showing the operation of the shade window according to the preferred embodiment of the present invention.

### DETAILED DESCRIPTION OF THE PREFERRED EMBODIMENTS

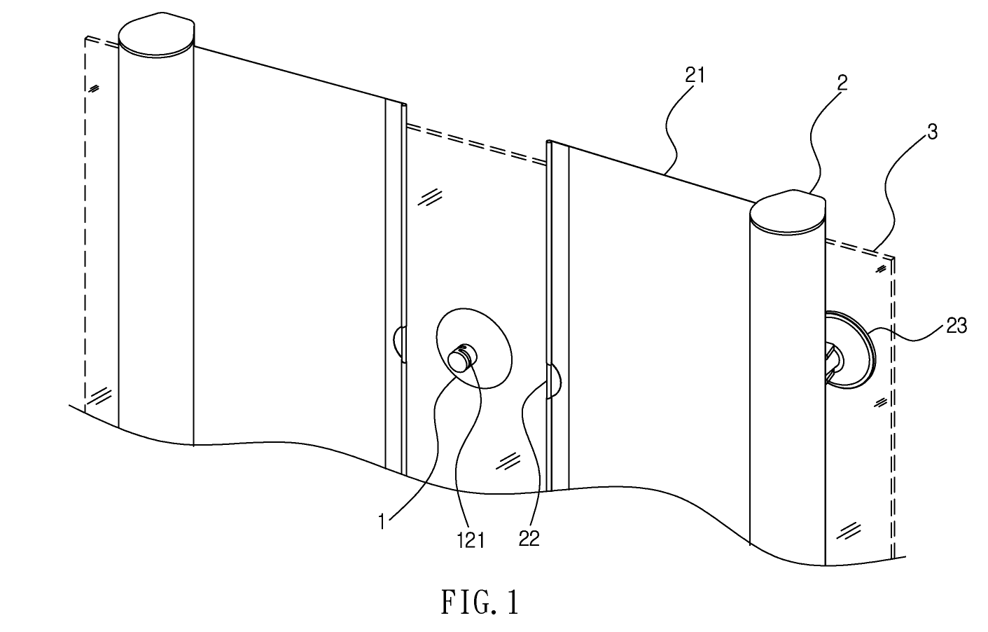

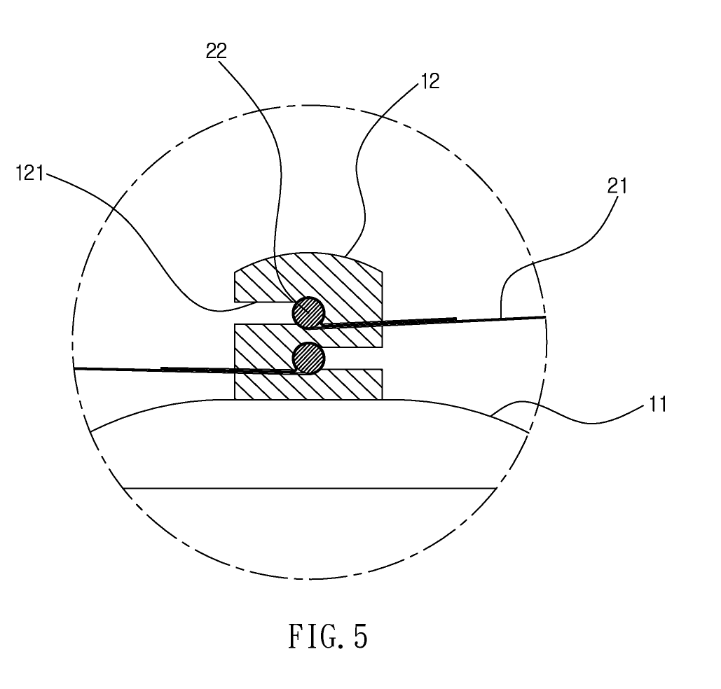

With reference to FIGS. 1 and 5, a window shade according to a preferred embodiment of the present invention is pulled from its one side or its two sides and comprises: at least one mounting holder 1 and two shading assemblies 2 mounted on two sides of a glass window 3.

Each mounting holder 1 includes a sucking portion 11 and a connecting portion 12, a first surface of the sucking portion 11 is an adhesion face 111 for adhering each mounting holder 1 with the glass window 3, and a second surface of the sucking portion 11 is an external face 112 formed with the connecting portion 12, wherein the connecting portion 12 has two retaining slots 121 defined on two peripheral sides thereof. Each shading assembly 2 includes an adjustable shading cloth 21 which is pulled outwardly, wherein the adjustable shading cloth 21 has a positioning post 22 disposed on one side thereof to retain with each of the two retaining slots 121.

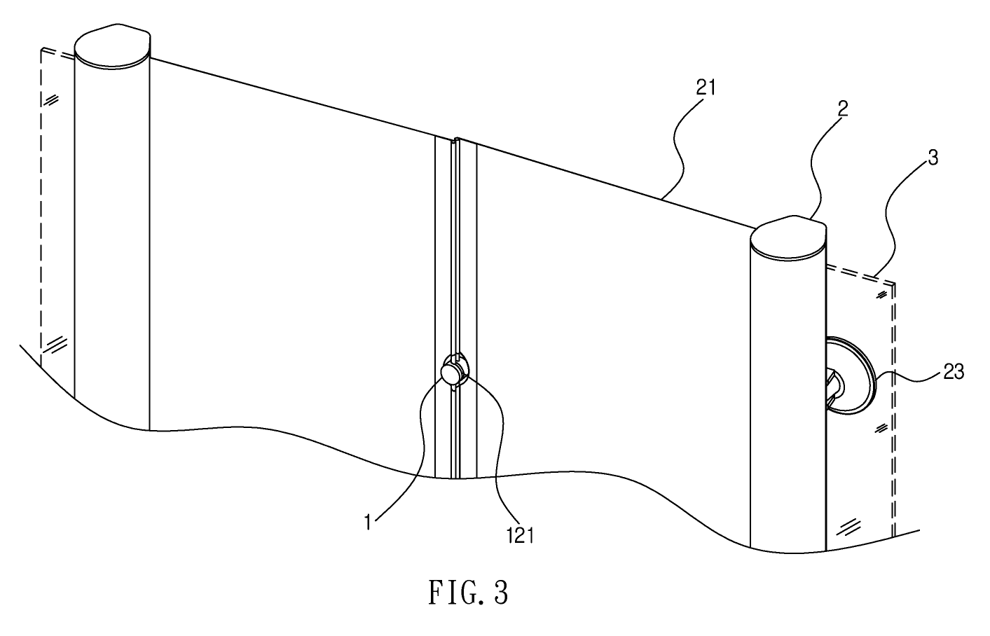

In operation, two mounting holders 11 are fixed on two ends of a middle section of the glass window 3 (as shown in FIG. 1), and two retaining slots 121 of the connecting portion 12 of each mounting holder 1 correspond to the two sides of the glass window 3, then each adjustable shading cloth 21 of each shading assembly 2 is pulled outwardly so that the positioning post 22 retains with each retaining slot 12, thus expanding and fixing each adjustable shading cloth 21 (as illustrated in FIG. 3).

It is to be noted that the two retaining slots 121 are located on the two peripheral sides of the connecting portion 12 at two different heights, such that when the two shading assemblies 2 are retained with the two retaining slots 121 of the connecting portion 12 through each mounting holder 1, two adjustable shading clothes 21 of the two shading assemblies 2 do not interfere with each other.

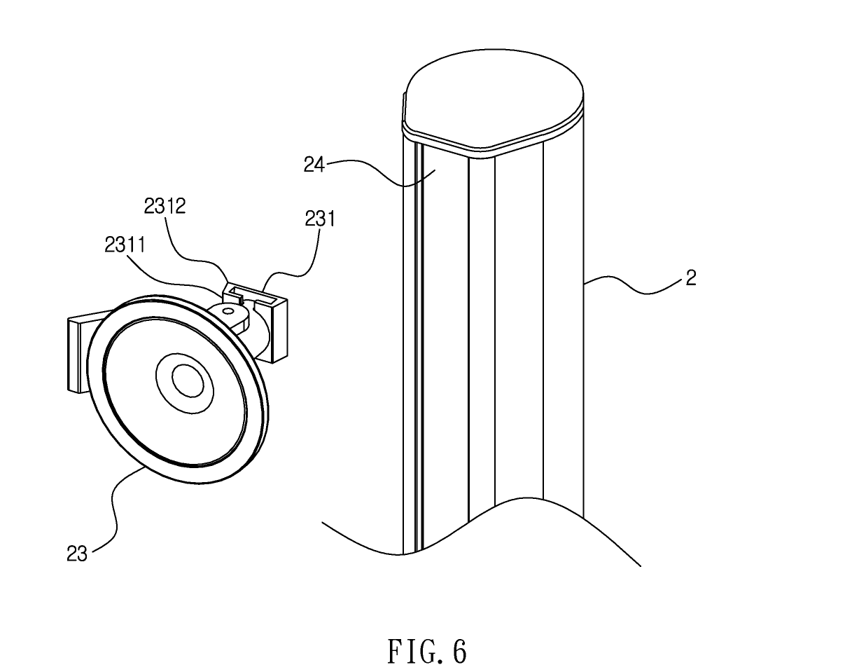

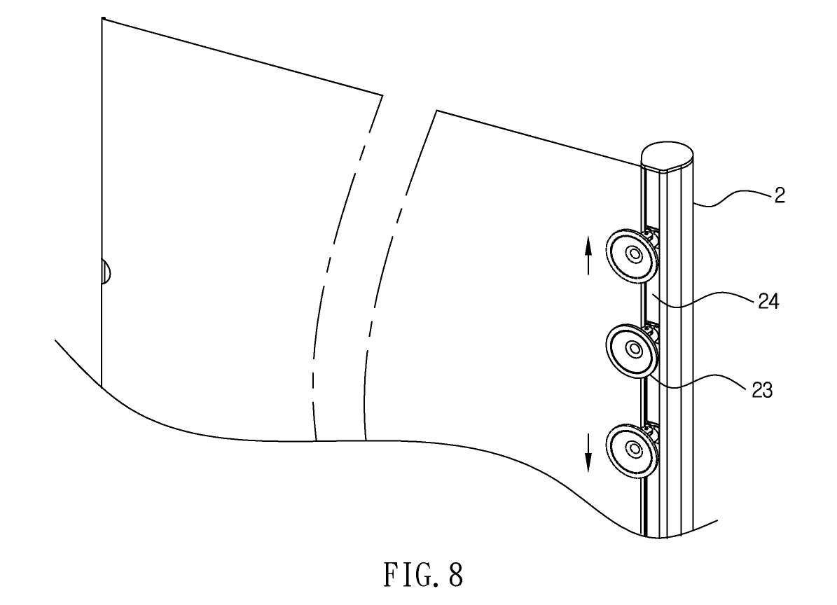

Referring to FIGS. 6 and 8, each shading assembly 2 further includes a plurality of suckers 23 arranged thereon and a locking groove 24 extending from a top end of each shading assembly 2 to a bottom end of each shading assembly 2, wherein each sucker 23 has a retaining block 231 arranged on one end thereof to slidably retain each sucker 23 with the locking groove 24, such that the plurality of suckers 23 are adjusted their spacing distance in the locking groove 24, thus adjusting using length of the window shade based on requirement.

Preferably, a width of an opening of the locking groove 24 is less than an inner surface of the locking groove 24, and the retaining block 231 of each sucker 23 has a narrow section 2311 and a wide section 2312 which cooperate with a profile of the locking groove 24, such that when the retaining block 231 retains with the locking groove 24, the wide section 2312 retains with the locking groove 24 tightly to avoid each sucker 23 removing from the locking groove 24.

Accordingly, the window shade of the present invention is upward pulled its two sides simultaneously. Preferably, after the window shade is collapsible, it is stored beside two columns A on two sides of the glass window of a car, thus decreasing a blind angle of the glass window. The window shade of the present invention allows cooperating with a window film with anti-UV and anti-infrared function to shade sunshine. Preferably, when the window shade is fixed on a windshield, its half is pulled to shield sunshine, and a driver still can view traffic states clearly.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A window shade comprising: at least one mounting holder and two shading assemblies mounted on two sides of a glass window, wherein
each mounting holder includes a sucking portion and a connecting portion, a first surface of the sucking portion is an adhesion face for adhering each mounting holder with the glass window, and a second surface of the sucking portion is an external face formed with the connecting portion, the connecting portion has two retaining slots defined on two peripheral sides thereof;
each shading assembly includes an adjustable shading cloth which is pulled outwardly, the adjustable shading cloth has a positioning post disposed on one side thereof to retain with each of the two retaining slots.

2. The window shade as claimed in claim 1, wherein the two retaining slots are located on the two peripheral sides of the connecting portion at two different heights.

3. The window shade as claimed in claim 1, wherein each shading assembly further includes a plurality of suckers arranged thereon and a locking groove extending from a top end of each shading assembly to a bottom end of each shading assembly, wherein each sucker has a retaining block arranged on one end thereof to slidably retain each sucker with the locking groove.

4. The window shade as claimed in claim 3, wherein a width of an opening of the locking groove is less than an inner surface of the locking groove, and the retaining block of each sucker has a narrow section and a wide section which cooperate with a profile of the locking groove.
